(19) United States
(12) Patent Application Publication
(10) Pub. No.: US 2005/0213132 A1
(43) Pub. Date: Sep. 29, 2005

(54) Print management device, print management method, storage medium, and print system

(75) Inventor: Hiroyoshi Uejo, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/962,698

(22) Filed: Oct. 13, 2004

(30) Foreign Application Priority Data
Mar. 23, 2004 (JP) 2004-084597

(51) Int. Cl. G06F 15/00

(52) U.S. Cl. 358/1.13

(57) ABSTRACT

A print management device manages the print-related service to be performed by a processing unit. The print instruction contains a request item indicating a request to produce printed matter. The print management device includes an input unit that inputs the print instruction; an acquiring unit that acquires unique data indicative of characteristics of the processing unit and a description format which can be interpreted by the processing unit; a generating unit that generates an operation instruction as to the request item contained in the inputted print instruction, the operation instruction being described in the description format which can be interpreted by the processing unit and being based on the unique data; and an output unit that outputs the generated operation instruction as the print instruction to the processing unit.

### CROSS-REFERENCE TO RELATED APPLICATION

This application claims priority under 35 USC 119 from Japanese Patent Application No. 2004-84597 the disclosure of which is incorporated by reference herein.

### BACKGROUND OF THE INVENTION

1. Field of the Invention

The present invention relates to a print management device, a print management method, a storage medium, and a print system. More particularly, the invention relates to a print management device, a method a storage medium, and a print system, for managing a print processing for producing printed matter through plural printing processes, such as printing using a printing plate or using an image forming device, such as a printer, having the so-called printing function of forming an image on a recording medium.

2. Description of the Related Art

In conventional printing (for example, offset printing), intermediate products such as printing paper for a photo composition or the like (photographic printing paper), a block copy, a halftone negative, halftone positive, and a PS plate (printing plate) are generated. On the basis of the intermediate products, printing, book binding, and the like are performed.

As shown in FIG. 7, for example, print processes are constituted by an imposition process, an RIP process, a CTP process, a printing machine process, a folding machine process, a cutting machine process, and a binding machine process. The imposition process is a process of determining an image position obtained by a layout, and the RIP process is a process of forming image data for printing on the basis of layout data. The CTP process is a process of forming a printing plate from image data, and the printing machine process is a process of performing printing using a printing plate. The folding machine process is a process of folding a printed medium depending on specifications, the cutting machine process is a process of cutting the printed and folded medium according to the specifications, and the binding machine process is a process of binding the printed, folded, and cut medium depending on the specifications. These print processes are independently performed, and include independent processes performed in the steps.

In recent years, along with the popularization of DTP (DeskTop Publishing/Prepress), “direct printing” or “on-demand printing” which directly performs printing from DTP data is known. In DTP, the following print processing is prevalent. That is, print data obtained by processing a page layout on a computer is formed on photographic printing paper, a process film, or the like, and, on the basis of these papers or films, a printing plate is formed to perform printing. Further, a CTP (Computer To Plate) process which directly forms a printing plate by electronic data without generating intermediate products is attracting attention. As a device which can be used in such print processing, an image forming device such as a printer or a copying machine having a print function is known.

Although, this DTP makes it possible to perform some processes of printing of peripheral devices of the image forming device by circulation of electronic data, it cannot be used in all processes of the print processing. In addition, DTP cannot be easily applied to conventional print processes.

Approaches for automatic control of a print workflow include CEP4 proposed by Heidelberger Druckmaschinen AG, which is being conformably supported by not only printer vendors but also prepress and postpress operations. This approach allows giving instructions, including abstract instructions and detailed instructions for devices, image processing, and operations, thereby achieving semiautomatic control of printing processes which have been heretofore manually performed.

Recently, an attempt has been made to use as printed matter an output (or a print) produced by electrophotography for printer-based digital color arrangement or on-demand printing. However, this attempt results in automation of only some processes, because it requires separate devices designed specifically for individual printing processes and thus renders difficult the overall management of a system.

A print system is configured to include devices designed specifically for printing processes (e.g., a printer and a CTP device). Most of the devices can interpret only data described according to their unique specifications. When printing processes are described in the form of print instructions so as to perform a printing operation, the descriptions of the print instruction are restricted by the specifications of devices when the devices are provided specifically for the individual printing processes. This makes it difficult to interpret print instructions described in plural different description formats, and consequently makes it impossible to accomplish plural printing processes.

### SUMMARY OF THE INVENTION

The present invention is designed to address the foregoing problems. The invention provides a print management device, a print management method, a storage medium, and a print system, which are not limited by the description formats of print instructions when executing plural printing processes in order to produce printed matter.

A first aspect of the invention is to provide a print management device for managing a print-related service to be performed by a processing unit which performs the print-related service according to a print instruction containing a request item indicating a request to produce printed matter including: an input unit that inputs the print instruction; an acquiring unit that acquires unique data indicative of characteristics of the processing unit when it performs the print-related service and a description format which can be interpreted by the processing unit; a generating unit that generates an operation instruction as to the request item contained in the inputted print instruction, the operation instruction being described in the description format which can be interpreted by the processing unit and being based on the unique data; and an output unit that outputs the generated operation instruction as the print instruction to the processing unit.

The print instruction includes electronic data. The contents of the print instruction include print-related processes which execute plural printing processes which provide print-related services classified in advance into processes from the request to the delivery of printed matter, and the print-related processes are each described for each printing process. The processing unit is provided for each printing process, and the processing unit interprets the print instruction and performs the print-related service in its corresponding printing process. To manage the print-related service to be performed by the processing unit, the acquiring unit acquires the unique data indicative of characteristics of the processing unit when the processing unit performs the print-related service. This makes it possible to grasp the characteristics of the processing unit for the processing unit to execute a process (e.g., characteristics unique to the processing unit). The acquiring unit also acquires the description format which can be interpreted by the processing unit. This makes it possible to determine whether or not the print instruction can be interpreted.

In the first aspect of the invention, the input unit inputs as the print instruction, for example, the print instruction containing the print-related processes which execute plural printing processes and are each described for each printing process. The print system includes the processing unit which performs its corresponding print-related service in the printing process. Since the print instructions for processes include those described in a predetermined description format or a different description format from the predetermined description format, the print system may be configured in an environment in which these description formats coexist. Thus, the acquiring unit acquires the description format which can be interpreted by the processing unit. Preferably, the acquiring unit is provided for each processing unit for each printing process included in the print system. The processing unit includes various types of equipment, and each of equipment often has unique characteristics. Thus, the acquiring unit acquires the unique data indicative of characteristics of the processing unit (e.g., characteristics unique to the processing unit) when the processing unit performs the print-related service. Acquisition of the unique data can be accomplished by referring to a memory which stores a predefined description format of the processing unit in tabular or other form. The generating unit generates the operation instruction as to the request item contained in the inputted print instruction, and the operation instruction is described in the description format which can be interpreted by the processing unit, based on the unique data. The result of acquisition by the acquiring unit can be used to determine whether or not the description format can be interpreted by the processing unit. When the result of acquisition by the acquiring unit indicates that the print instruction can be described in plural description formats, an operator uses a selection unit such as a keyboard to enter an instruction to determine the description format, or a preset description format is automatically selected. The output unit outputs the operation instruction generated by the generating unit as the print instruction to the processing unit.

As mentioned above, the generating unit generates the print instruction whose description format can be interpreted by the processing unit, for the processing unit included within the print system. Then, the output unit outputs the generated print instruction. This eliminates limitation of the description format, in advance, to that which can be interpreted by the processing unit, and thus eliminates limitation of the configuration of the print system. In other words, the processing unit can be added to the print system without being limited by the description format. Therefore, the print system can be configured regardless of a unique interface such as specifications unique to equipment which acts as the processing unit provided for the printing process. Even when a new processing unit is provided, the processing unit can be added to the print system without being limited by the description format.

As mentioned above, when the processing unit performs the print-related service, a device or the like which manages the process receives input of the print instruction. The generating unit generates the operation instruction as to the request item contained in the inputted print instruction, the operation instruction being described in the description format which can be interpreted by the processing unit, and being based on the acquired unique data. Then, the output unit outputs the generated operation instruction as the print instruction to the processing unit. This enables the processing unit to move to the process without being limited by the description format of the print instruction. Therefore, the print system can be configured regardless of an interface unique to the processing unit, such as specifications unique to equipment, when the processing unit executes plural printing processes in order to produce printed matter. Moreover, the print system can be configured without being limited by the description format of the print instruction. This makes it possible to configure the processing unit using various devices, and thus facilitates automation of the print system.

As mentioned above, the print management device of the invention can acquire the unique data indicative of the characteristics of the processing unit, and can acquire the description format which permits the print instruction to be interpreted. Thus, the print management device can output the print instruction having the corresponding description format. Therefore, even when there are print instructions described in different description formats, the print system can execute the printing process therein. Thus, the print management device of the invention has the excellent advantage and facilitating an improvement in performance or function of the print system.

A second aspect of the invention is to provide a print management method for managing a print-related service to be performed by a processing unit which performs the print-related service according to a print instruction containing a request item indicating a request to produce printed matter, including: inputting the print instruction; acquiring unique data indicative of characteristics of the processing unit and a description format which can be interpreted by the processing unit; generating an operation instruction as to the request item contained in the inputted print instruction, the operation instruction being described in the description format which can be interpreted by the processing unit and being based on the unique data; and outputting the generated operation instruction as the print instruction to the processing unit.

The print system requires the management of the print processing for producing printed matter. As for the print processing of the print system for producing printed matter, the second aspect of the invention enables the coexistence of both print instructions described in a predetermined description format and those described in a different description format from the predetermined description format. Moreover, the second aspect of the invention enables the system to easily execute the process, even when the processing unit can interpret only a corresponding instruction manual.

A third aspect of the invention is to provide a computer-readable storage medium which stores a program to perform a processing of managing print processing for printed matter executable by a print management device, the print management device managing the print-related service to be performed by a processing unit which performs a print-related service according to a print instruction containing a request item indicating a request to produce printed matter, including: inputting the print instruction; acquiring unique data indicative of characteristics of the processing unit when it performs the print-related service and a description format which can be interpreted by the processing unit; generating an operation instruction as to the request item contained in the inputted print instruction, the operation instruction being described in the description format which can be interpreted by the processing unit and being based on the unique data; and outputting the generated operation instruction as the print instruction to the processing unit.

In the print management device, the management of the print processing for producing printed matter requires a program for managing the print processing. In the print management device, as for the printing operation for producing printed matter, the print management program enables the coexistence of both print instructions described in a predetermined description format and those described in a different description format from the predetermined description format. Moreover, the program enables the system to easily execute the process, even when the processing unit can interpret a corresponding each instruction manual.

In the print management device, a medium is necessary for the execution of the program for managing the print processing for producing printed matter. Thus, according to the third aspect of the invention, the program for managing the print processing for producing printed matter is stored in the computer-readable storage medium, and this facilitates reading and executing the program.

A fourth aspect of the invention is to provide a print system which performs a print-related service according to a print instruction containing a request item indicating a request to produce printed matter, the system including: at least one processing unit corresponding to at least one printing process, the processing unit being classified in advance according to printing processes which provide print-related services classified in advance between the request and the delivery of printed matter; and a print management device that manages a print processing for printed matter to be performed by the processing unit, wherein the print management device includes: an input unit that inputs the print instruction; an acquiring unit that acquires unique data indicative of characteristics of the processing unit when it performs the print-related service and a description format which can be interpreted by the processing unit; a generating unit that generates an operation instruction as to the request item contained in the inputted print instruction, the operation instruction being described in the description format which can be interpreted by the processing unit and being based on the unique data; and an output unit that outputs the generated operation instruction as the print instruction to the processing unit.

The print system can have a configuration in which the processing unit is electrically connected to the print management device via a local area network or the like. Thus, the print system of the fourth aspect of the invention includes a processing unit corresponding to at least one printing process, the processing unit being classified in advance according to printing processes which provide print-related services classified in advance from the request to the delivery of printed matter; and a print management device which manages a print processing to be performed by the processing unit. Thus, as for the print processing for producing printed matter, the print system can execute both print instructions described in a predetermined description format and those described a different description format from the predetermined description format, according to individual processing units.

### BRIEF DESCRIPTION OF THE DRAWINGS

Embodiments of the present invention will be described in detail based on the following figures, wherein:

FIG. 1 is a block diagram showing the configuration of a print system according to an embodiment of the present invention;

FIG. 2 is a block diagram showing the basic configuration of devices which constitute the print system according to the embodiment of the invention;

FIG. 3 is a block diagram for explaining the interrelations among the devices which constitute the print system;

FIGS. 4A through 4D are image diagrams showing a configuration of a print instruction and a flow of data addition, in which FIG. 4A shows only basic fields, FIG. 4B shows fields including specifications required by a user, FIG. 4C shows fields including specifications for each print-related process, and FIG. 4D shows fields including detailed specifications for each print-related processes;

FIG. 5 is a process flowchart showing coordination processes from the request for printed matter to the output of the printed matter;

FIG. 6 is a process flowchart showing a process which is executed by a processing unit assigned to one print-related process;

FIG. 7 shows the flow of a conventional printing process; and

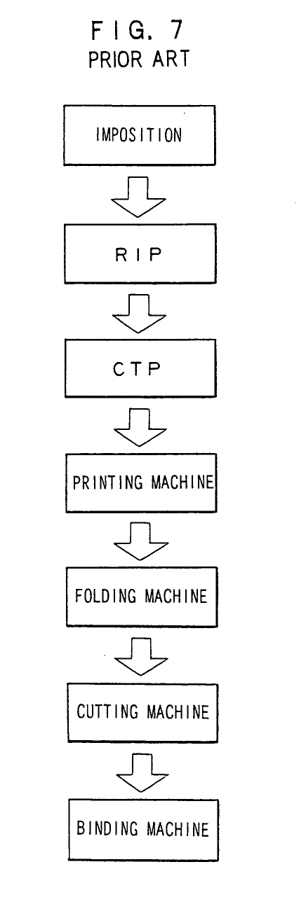

FIG. 8 is a process flowchart which is executed by a print instruction containing a printing process for color proofing.

### DETAILED DESCRIPTION OF THE INVENTION

Embodiments of the present invention will be described in detail below with reference to the drawings.

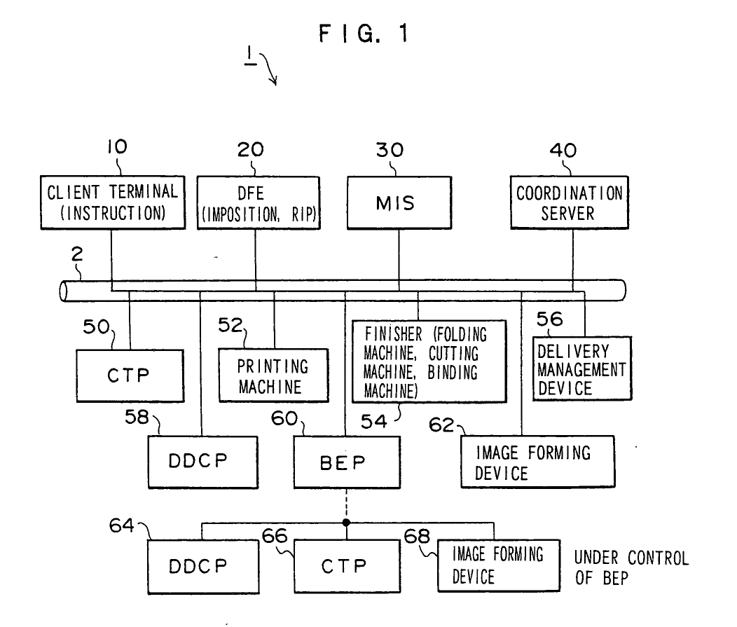

FIG. 1 is a block diagram showing the configuration of a print processing system 1 according to an embodiment of the invention.

The print processing system 1 is obtained by connecting devices for realizing various services related to print processings through a network 2. In this case, the services mean functions which are related to printing and can be utilized in response to an external request. The services correspond to, for example, formation of layout data, imposition, data conversion, formation of a printing plate, printing, folding, cutting, and binding processes. However, the services are not limited to these processes.

More specifically, the print processing system 1 includes a client terminal 10 having a user interface which instructs print processings for ultimately obtaining a printed matter desired by a user by plural services, a DFE (Digital Front End Processor) device 20, a MIS (Management Information System) device 30, a coordination server 40, a CTP (Computer To Plate) device 50, a printer 52, a finisher device 54, and a delivery management device 56.

The DFE device 20 passes print data to an image forming device such as the CTP or a printer and gives a print instruction to the image forming device. The MIS device 30 controls a device which is assigned to a service according to a print instruction containing information of a service procedure instructed by the client terminal 10. In this case, the information is described in a predetermined description format (e.g., JDF: Job Definition Format). The coordination server 40 controls nodes such as devices or programs which are assigned to services according to a print instruction containing information of service coordination instructed by the client terminal 10. In this case, the information is described in another description format. The print instructions described in these description formats can be expressed in a predetermined language (e.g., XML: Extensible Markup Language). In other words, the predetermined or another description format can be expressed in XML so as to generate the print instruction. Incidentally, the language is not limited to XML. The CTP device 50 makes a printing plate directly based on print data without having to generate intermediate products. The printer 52 performs printing using the printing plate made based on the print data. The finisher device 54 folds, cuts, and binds printed paper so that the user obtains desired (e.g., bound) printed matter. The delivery management device 56 manages the delivery of the printed matter to the user.

Further, a DDCP (Digital Direct Color Proofing) device 58, a BEP (Back End Processor) device 60, and an image forming device 62 are connected to the network 2. The image forming device 62 is a device such as a color copying machine, a facsimile, a printer or the like having a so-called printing function which forms an image on a recording medium by an electrophotography. The image forming device 62 can have a device configuration including the function of the finisher device 54. The DDCP device 58 may be an output device which directly performs print output for color proofing from DTP data or an output device which outputs a large-size print imposed for plate making. The BEP device 60 is a device including a function which performs various processings for data obtained by converting print data obtained by instruction of a client to raster data (RIP processing). The BEP device 60 can be connected to output devices such as a DDCP device 64 similar to the DDCP device 58, a CTP device 66 similar to the CTP device 50, and an image forming device 68 similar to the image forming device 62. More specifically, under the management of the BEP device 60, at least one of the DDCP device 64, the CTP device 66, and the image forming device 68 can be connected.

The coordination server 40 can be realized to be include a service retrieving server which retrieves a service desired by a user, an instruction generating server which forms a print instruction from information related to service coordination instructed by the client terminal 10, an instruction management server which manages a print instruction, and a coordination processing server which executes a coordination processing for services according to the print instruction. In addition, the coordination server 40 can also include an image processing device which performs image processing such as a noise reduction process, an image rotating process, an OCR (Optical Character Recognition) process, and an image binding process for an image document, a document management server which manages a document, a document delivery server which delivers a document, and a service processing device which performs predetermined service processing.

Service coordination means that the services have relationships such that a result of an arbitrary service determines a service to be subsequently activated or affects the operation of a subsequent service. The services as referred to herein mean a function related to print processings which can be utilized in response to an external request. The services correspond to, for example, copying, printing, scanning, facsimile transmission/reception, mail delivery, storage in a repository, reading from a repository, an OCR processing, a noise reduction processing, and the like. However, the services are not limited to these processes. Therefore, the coordination server 40 coordinates plural services to instruct and manage print processings desired by a user. The coordination server 40 executes a coordination processing for the services according to a print instruction on the basis of information related to service coordination in the print instruction.

The print processing system 1 has a configuration in which plural devices which perform predetermined print-related processings are connected through the network 2 in this embodiment. However, the print processing system 1 is not limited to this configuration as long as plural services are connected through the network 2.

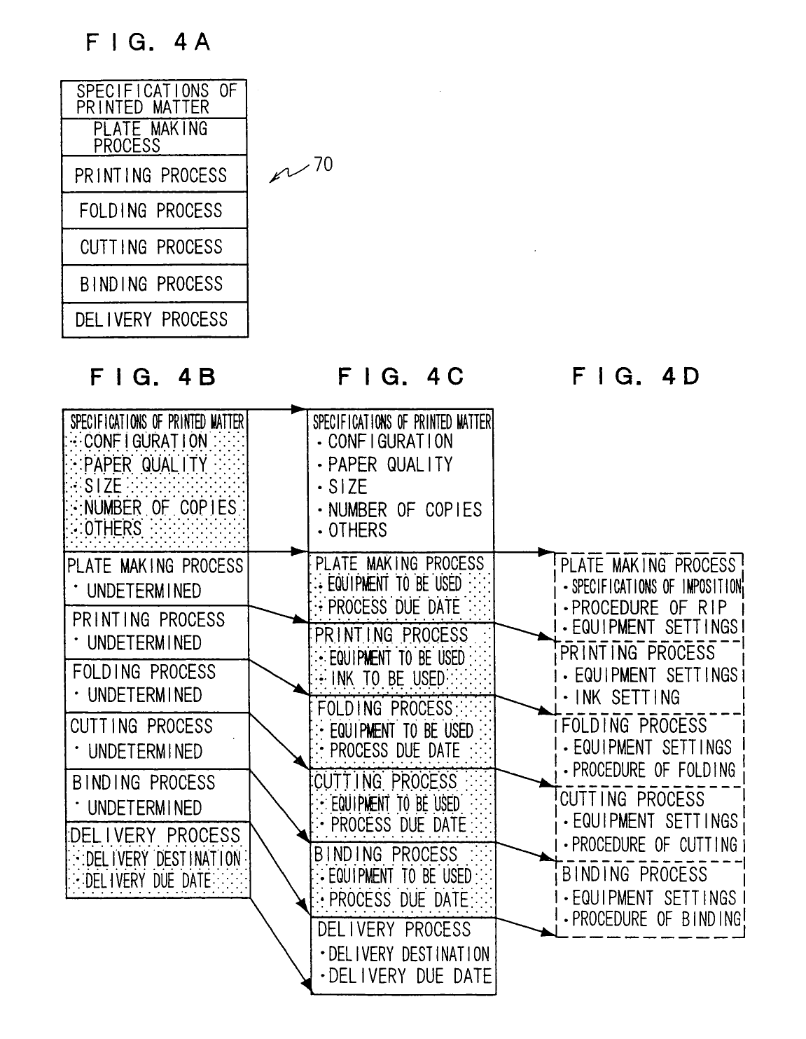

A series of processes related to printing is decomposed into plural functional processes, and in such case, the print instruction refers to data including information representing the relationships between the processes and parameter information used in the processings executed in each process. The print instruction is described in a predetermined description format (for example, JDF or the like) (see FIGS. 4A through 4D).

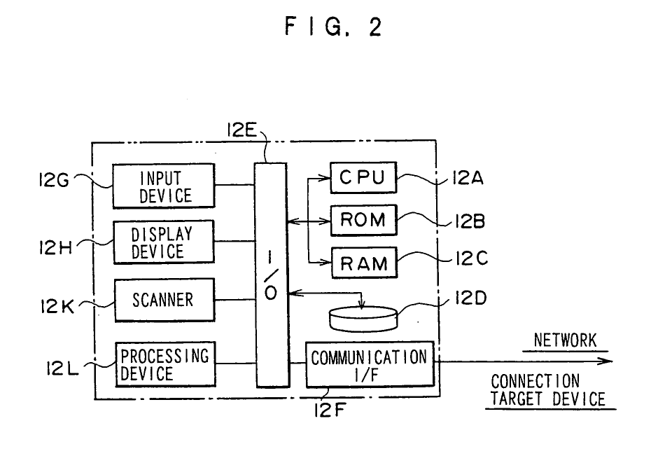

FIG. 2 comprehensively shows the client terminal 10 as an example of a basic configuration of a device constituting the print processing system 1. The client terminal 10 includes at least a CPU 12A, and the CPU 12A is connected to an input/output bus 12E (I/O in FIG. 2). A ROM 12B and a RAM 12C are elements related to the CPU 12A. An input device 12G such as a keyboard or a mouse, a display device 12H such as a display, and a scanner device 12K for reading an image can be connected to the input/output bus 12E. A processing device 12L such as a printer or a proofer for carrying out functions to be processed by itself and a communication interface 12F to be connected to the network 2 or a connection target device (local host) can be connected to the input/output bus 12E.

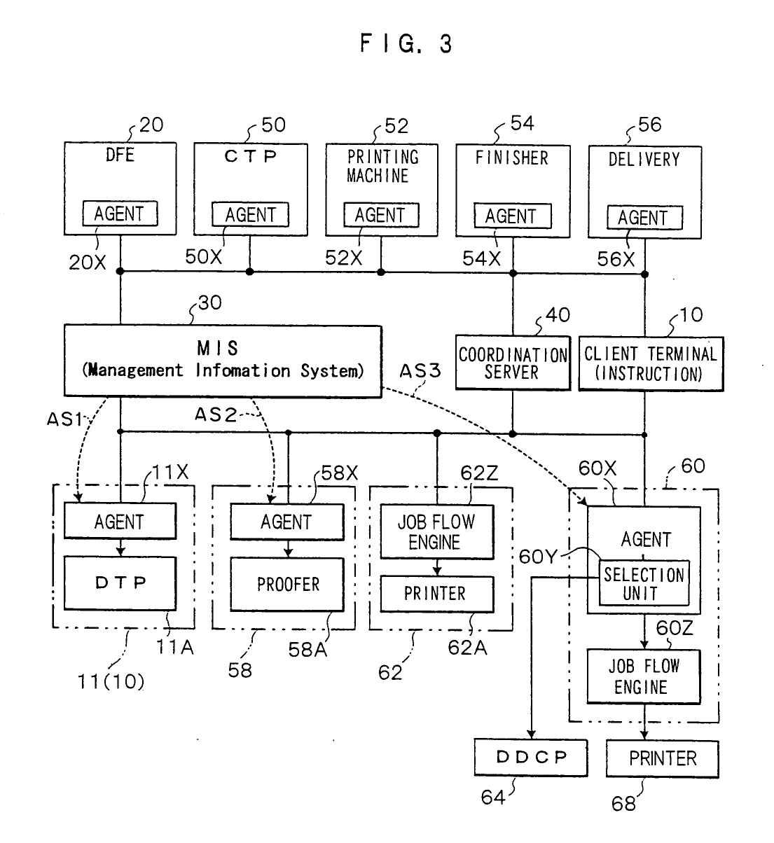

Hardware resources having these configurations and software resources which are processing programs stored in the ROM 12B and the RAM 12C activate the devices constituting the print processing system 1. The devices constituting the print processing system 1 have an agent function unit for interpreting a print instruction by using the hardware resources and the software resources (see FIG. 3). The agent function unit interprets the XML description format (for example, JDF or the like) described in the print instruction and performs a conversion processing between the description format (for example, JDF or the like) and a dedicated language used to activate the mechanism units and the processing units of the devices constituting the print processing system 1.

FIG. 3 is a block diagram for explaining the interrelations among the devices which constitute the print processing system 1. Each device has an agent function unit which stores interface information indicative of the contents of a service provided by the device and interprets the description contents of the print instruction. Hereinafter, the agent function unit can interpret the description contents of the print instruction described in a first description format (e.g., JDF), unless explicitly mentioned. The agent function unit can interpret the print instruction described in the first description format (e.g., JDF). In the embodiment, the agent function unit may have the function of generating a print instruction described in a description format other than the first description format such as JDF (e.g., XML representation using a description format other than JDF). This will be described in detail later.

Each device in FIG. 3 is shown so that the agent function unit is explicitly illustrated, based on each device shown in FIG. 1. The client terminal 10 can selectively use the print instruction described in the first description format (e.g., JDF) or the print instruction described in a second description format (e.g., XML representation using a description format other than JDF). A DTP device 11 can perform processing based on the print instruction described in the first description format (e.g., JDF). The DTP device 11 has an input editing function. Thus, the DTP device 11 processes a page layout into print data on a computer, and forms a photographic printing paper, a process film, or the like on the basis of the print data. Thus, the DTP device 11 includes an agent function unit 11X and a DTP function part 11A. The DTP device 11 may function to perform only a processing of receiving print data of a page layout generated by the client terminal 10 and forming the print data on photographic printing paper, a process film, or the like.

Of the devices in FIG. 3, the DFE device 20, the CTP device 50, the printer 52, the finisher device 54, the delivery management device 56, and the DDCP device 58 can perform processing based on the print instruction described in the first description format (JDF). In addition, the MIS device 30 integrally manages print instructions described in JDF. On the other hand, the coordination server 40 integrally manages a print instruction described in the second description format (for example, XML expression obtained by a description format other than JDF).

In FIG. 3, the image forming device 62 is different in configuration from the image forming device 68. Specifically, the image forming device 62 is connected directly to the network 2, and the image forming device 68 is under control of the BEP 60. In the embodiment, the image forming device 62 performs processing based on the print instruction described in the second description format (e.g., XML representation using a description format other than JDF). Thus, the image forming device 62 includes a job flow engine 62Z for interpreting the print instruction described in the second description format, and a printer 62A. Specifically, the job flow engine 62Z interprets the print instruction described in the second description format (e.g., XML representation using a description format other than JDF), converts data based on the inputted print instruction into data unique to the specifications of the printer 62A, and outputs the converted data to the printer 62A. Therefore, the job flow engine 62Z may be regarded as an agent function unit which interprets the print instruction described in the second description format.

The BEP device 60 is configured to perform both processing based on the print instruction described in the first description format (e.g., JDF) and processing based on the print instruction described in the second description format by using the devices under control of the BEP device 60. Thus, the BEP device 60 includes an agent function unit 60X for interpreting both the print instructions described in the first description format and those described in the second description format. The BEP device 60 may have the function of performing conversion from the first description format into the second description format and vice versa. The agent function unit 60X includes a selection unit 60Y which selects a device capable of performing processing based on the print instruction described in the first description format, or a device capable of performing processing based on the print instruction described in the second description format, as a output destination which the agent function unit 60X is to be connected to. The DDCP device 64 is connected to the selection unit 60Y, and the image forming device 68 is also connected to the selection unit 60Y via a job flow engine 60Z for interpreting the print instruction described in the second description format.

FIGS. 4A through 4D are diagrams showing the configurations of print instructions and a flow of addition of data to the print instruction. As shown in FIG. 4A, the print instruction is constituted by basic fields of <printed matter specification>, <plate-making process>, <print process>, <folding process>, <cutting process>, <binding process>, and <delivery process>. The print instruction is described in a predetermined description format (for example, XML expression by JDF or a description format other than JDF).

<Printed matter specification> shows items of the specification of a printed matter itself serving as an output result of the print processing system 1. In <printed matter specification>, predefined items are used. Inputting and setting of these items are mainly performed in sales and marketing departments which recognize demands of users such as a customer who requests a printed matter. For example, configuration, paper quality, a size, the number of copies, and the like correspond to the items. <Plate-making process> includes items for stipulating a plate-making for printing. Inputting and setting of these items are mainly performed in a process management department or the like which manages plate-making formation processes. For example, a device to be used for a plate-making, a process due date, and the like correspond to the items. <Print process> includes items for substantially stipulating processes for printing. Inputting and setting of these items are mainly performed in a process management department for managing print processes. For example, a device to be used for printing, inks to be used, and the like correspond to the items.

<Folding process> includes items for stipulating a folding process for an output printed matter. Inputting and setting of these items are mainly performed in a process management department or the like which manages a folding process. For example, a device to be used for folding, a process due date, and the like correspond to the items. <Cutting process> includes items for stipulating a cutting process for a printed output or an output obtained after the folding process. Inputting and setting of these items are mainly performed in a process management department for managing the cutting process. For example, a device to be used for cutting, a process due date, and the like correspond to the items. <Binding process> includes items for stipulating a binding process for one of a printed output, an output obtained after the folding process, and an output obtained after the cutting process. Inputting and setting of these items are mainly performed in a process management department which manages the binding process. For example, a device to be used for binding, a process due date, and the like correspond to the items.

In a print instruction 70 in which a concrete configuration is not described as shown in FIG. 4A, a request from a requester of a printed matter is received, whereby <printed matter specification> and <delivery process> are determined. Then the determinate items are described in the print instruction 70 as shown in FIG. 4B. This processing is mainly performed by an input operation of the client terminal 10. In this case, since concrete items of the print processes performed according to the print instruction 70 are not determined, the print instruction 70 is distributed to the respective processes. As shown in FIG. 4C, data in the fields <plate-making process>, <print process>, <folding process>, <cutting process>, and <binding process>, are determined by the respective processes and the determined items are described in the print instruction 70. This processing is performed by devices for the respective processes, and is not basically affected by the other devices (processes). More specifically, the items determined for the processes shown in FIG. 4C may be data corresponding to specification items processed in the corresponding processes, and detailed data regarding the content of the processes are not necessary. However, when processings are actually performed in the processes, detailed specifications must be determined. Thus, as shown in FIG. 4D, in the processes, detailed specification items used in processings in the processes are determined and performed.

A user executes a coordination processing for obtaining a printed matter by reading out a print instruction. More specifically, the coordination processing is executed as follows.

For the sake of simplicity, description is given with regard to the case where the MIS device 30 and the coordination server 40 are used as control devices which are assigned to processing for each description format of a print instruction. Specifically, description is given by taking as an example the case where the MIS device 30 is assigned to a print instruction using as a first description format a JDF-based format (hereinafter referred to as a JDF), and the coordination server 40 is assigned to a print instruction using as a second description format a XML description format using a format other than JDF (hereinafter referred to as a another description format).

The client terminal 10 has a function of a graphical user interface (GUI) to perform screen display or a predetermined operation to instruct preparation of a print instruction or select a print instruction to be activated.

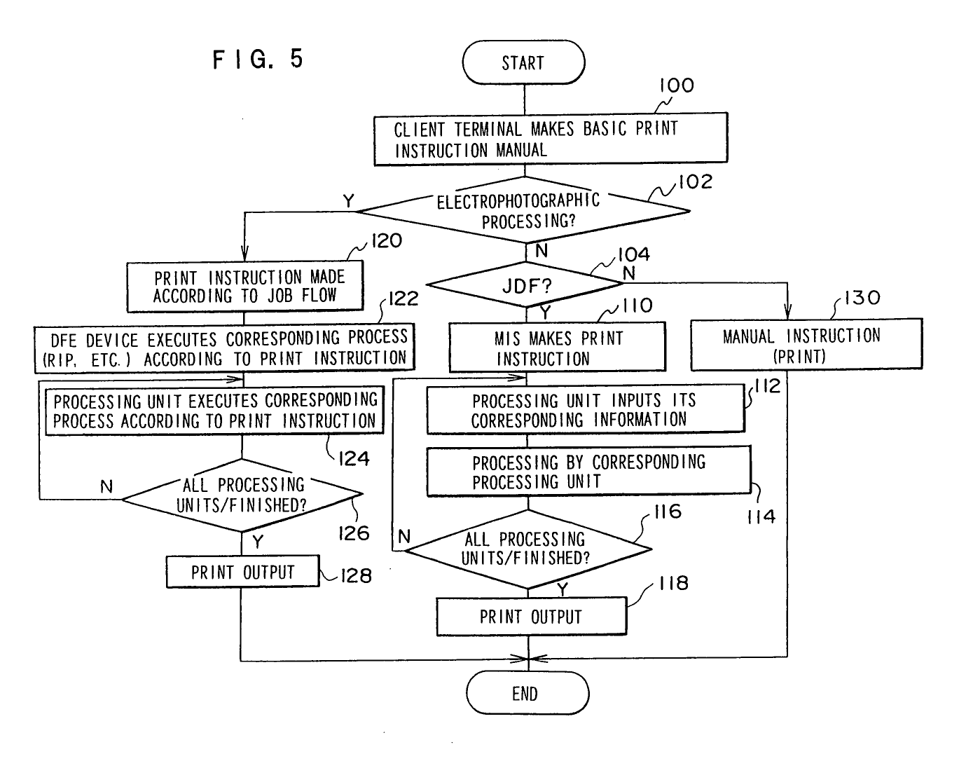

FIG. 5 shows a process flow chart related to the coordination processing of the flow from a requesting of a printed matter to obtaining the printed matter.

The client terminal 10 stores a print instruction (see FIG. 4A) constituted by blank fields in advance, and reads the stored basic print instruction (step 100). In the client terminal 10, the read basic print instruction 70 is displayed, and initial necessary items are described in the basic print instruction due to an inputting operation by a user, so that the basic print instruction 70 expressing a request for a printed matter is formed and output to the outside.

In this case, as the description format of the print instruction 70, any one of a print instruction described in another description format, a print instruction described in JDF, and a print instruction for manual instruction is selectively instructed. At this time, in order to omit selection of the print instructions by a user who operates the client terminal 10, any one of the print instructions may be set as a default value.

The print instructions are not limited to being stored in the client terminal 10. For example, the print instructions may be stored in the MIS device 30 in advance and read from the MIS device 30. In addition, an accumulation server which accumulates print instructions can be connected to the network 2, and the print instructions may be read from the accumulation server. In addition, the accumulation server function can be given to another device connected to the network 2 to enable the device to output a print instruction in response to a request. Furthermore, plural print instructions may be given to other devices connected to the network 2 such that the print instructions are dispersed or shared, so that a user can retrieve a desired print service related to printing from plural devices connected to the network 2.

As the print instruction 70, any one of a print instruction described in another description format, and the print instruction described in JDF, the print instruction for manual instruction is selectively instructed. Thus, a process performed until a printed matter corresponding to a request is obtained is different in each process. Namely, the print instructions of the three types are discriminated from each other (steps 102 and 104). When the print instruction described in another description format is selected (the determination is affirmative in step 102), a print instruction is prepared in the coordination server 40 (step 120). When the print instruction in JDF is selected (the determination is negative in step 102 and the determination is affirmative in step 104), a print instruction is prepared in the MIS device 30 (step 110). In addition, when the print instruction for manual instruction is selected (the determination is negative in steps 102 and 104), the print instruction is printed (step 130).

In step 102, the MIS device 30 and the coordination server 40 may be used to determine the type of description format of the print instruction, or a processing unit having a determination function may be provided in the print processing system 1 and used to determine the type of description format thereof.

In the print processing system 1 according to the embodiment, a processing device for processing a print service executes the following processes corresponding to each format of a print instruction.

Print Instruction of JDF

Processes corresponding to the print instruction of JDF will be described below. When the basic print instruction is a print instruction described in JDF, a print instruction is prepared in the MIS device 30 (step 110).

In the print instruction described in JDF, not all pieces of information related to control of coordination processing of services related to printing are not described, and basic fields serving as processes related to printing (to be referred to as a print-related process hereinafter) are described, and items in the fields are sequentially filled by devices which perform each service. In order to realize the coordination processing, the MIS device 30 can generate a print instruction (see FIG. 4A) serving as a base for coordinating the print-related processes (services executed in the print-related processes). More specifically, the MIS device 30 acquires or retrieves location information expressing a position of a device which is assigned to or manages the print-related processes (services) on the network 2, so that the processing devices which process the print-related processes dispersed on the network 2 are recognized and managed. The MIS device 30 generates an HTML file serving as a GUI screen for reflecting a request from a user with respect to the basic print instruction, and transmits the basic print instruction to the client terminal 10 in response to a request.

The client terminal 10 transmits the HTML file including the items in the fields defined by an operation of a user to the MIS device 30. The MIS device 30 receives the HTML file and prepares a print instruction in which the request from the user is reflected (see FIG. 4B). The print instruction is constituted by a file described in JDF.

The MIS device 30 can manage devices which interpret, execute, and associate the print instructions. The MIS device 30 interprets the basic print instruction received from the client terminal 10, outputs a instruction to the processing devices according to the print-related processes described in the print instructions, and executes the print coordination processing. The MIS device 30 stores information of a status of an active coordination processing and information of the finished coordination processing, and can carry out notification of the status and result of the coordination processing in response to an external request.

When the MIS device 30 interprets the print instructions and makes a request to the processing devices assigned to the print-related processes, the MIS device 30 need not generate individual instruction information including processing request contents, an input parameter, and information for specifying a document to be processed. The request is processed in the print-related processes or the like. More specifically, the request from the MIS device 30 to the processing devices carries out notification only that the print-related processes are requested unless there is a special instruction made by a user. In addition, the processing devices assigned to the print-related processes carries out notification of information related to specifications until a printed matter is obtained, such as the available devices and a due date required in response to requests to the MIS device 30. On the basis of the information, the MIS device 30 can fill the fields of the print instruction 70.

Specific processes are as follows.

Each processing device assigned to the print-related processes carry out notification of interface information including information representing the outline of the print-related processes and addresses to the MIS device 30. The processing devices assigned to the print-related processes set various specifications for managing the details of each print-related process. The MIS device 30 stores interface information transmitted from the processing devices assigned to the print-related processes.

According to an operation of a user, the client terminal 10 accesses a URL (Uniform Resource Locator) of an HTML file generated for a user interface screen arranged in the client terminal 10 or provided by another server through an installed browser. In response to a browsing request, the HTML file (basic print instruction) of the user interface screen is transmitted from the access destination to the client terminal 10, and the screen is displayed on the client terminal 10. At this time, a user can specifications for obtaining a desired printed matter by using the user interface screen displayed on the client terminal 10. More specifically, the user inputs items such as the specifications of the desired printed matter.

When the specifications of the printed matter are defined through the interface screen, the client terminal 10 transmits a print instruction including the specifications of the printed matter defined by the user (HTML file including the items in the fields defined by an operation of the user) to the MIS device 30.

The MIS device 30 forms the print instruction which defines the information for specifying the print-related processes on the basis of the print instruction (HTML file) including the specifications of the printed matter transmitted from the client terminal 10 and the interface information acquired from the processing devices (step 110). In this manner, the MIS device 30 obtains a print instruction described in JDF.

The MIS device 30 starts execution of the coordination processing depending on the print instruction obtained by the instruction of the client terminal 10 (steps 112 to 118). The MIS device 30 interprets the print instruction from the client terminal 10, and notifies a processing device assigned to execute one described print-related process that the print-related processes are instructed and requested. In response to the notification, in the processing devices assigned to the print-related processes, the information related to the specifications required until the printed matter is obtained such as available devices in the processes and a due date is input, and notified to the MIS device 30 (step 112). At that time, in the processing devices, concrete individual instruction information including information of processing request contents, an input parameter, and information for specifying a document to be processed or the like is generated. The processing devices execute the processing of the requested print-related processes (step 114). The MIS device 30 repeats the above processes until all of the instruction of the print-related processes described in the print instruction have ended (step 116). The print-related processes mentioned here correspond to processings conducted by the DFE device 20, the CTP device 50, the printer 52, the finisher device 54, the delivery management device 56, the DDCP device 58, and the like.

When all of the processings have ended (the determination is affirmative in step 116), the completion of the processings according to the print instruction is recognized, and corresponding post-processings are executed (step 118). The post-processings correspond to processing for making the printed matter formed by the printer 52 a final printed matter by the finisher device 54 or a processing for managing delivery by the delivery management device 56.

Processing for only inquiry and reply of only completion of the print instruction can be performed (steps 112 to 116), and according to the print instruction generated as a result, a post-processing for a print output can be performed (step 118).

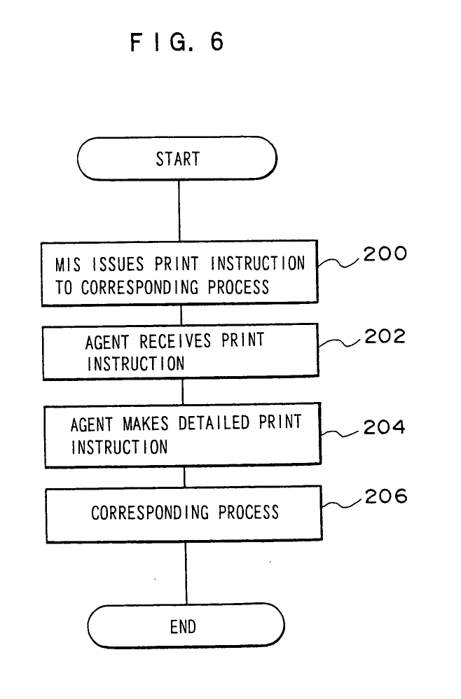

Next, description is given with regard to the details of the process executed by the processing unit in charge of one print-related process described in the print instruction from the client terminal 10 interpreted by the MIS device 30. FIG. 6 is a process flowchart showing the process which is executed by the processing unit which is assigned to one print-related process. Hereinafter, description is given with regard to the case where the <printing process> is taken as an example of the print-related process and the printer 52 is taken as an example of the processing unit in charge of the print-related process.

The MIS device 30 interprets the print instruction and requests the <print process> described in the print instruction to execute a corresponding service (print processing) (step 200). In this case, a print instruction described in JDF is issued to the printer 52, and the print instruction is received by an agent 52X of the printer 52 (step 202). The agent 52X interprets the received print instruction described in JDF and extracts the part corresponding to the assigned process. The agent 52X displays instruction or the like from the MIS device 30 on a user interface screen to urge a user who manages <print process> to input information related to the specifications required until a printed matter is obtained such as available devices in <print process> and a due date. In this manner, the user who manages <print process> inputs items of requested specifications of <print process>. The inputted items are notified to the MIS device 30. The state in which the items of specifications of <print process> are inputted is shown in FIG. 4C.

At the same time, in the agent 52X, the independent pieces of concrete individual instruction information including the processing request contents, the input parameter, and information for specifying the document to be processes are generated (step 204). Thus, the <print process> can be executed. An individual print instruction in which the items (in FIG. 4C, items of device setting and ink setting) of the concrete individual instruction information in the <print process> is shown in FIG. 4D. As a corresponding processing in <print process>, printing is performed such that the printer is operated by the individual print instruction shown in FIG. 4D (step 206).

Print Instruction in Another Description Format

Processes corresponding to a print instruction described in another description format will be described below. With respect to a coordination processing performed by the print instruction described in another description format, a technique for which application for a patent has been made by the present applicant exists (Japanese Patent Application No. 2002-275230 or the like). When a basic print instruction is described in another XML description format, a print instruction is formed in the coordination server 40 (step 120).

In the print instruction described in another description format, all information regarding control of a coordination processing for service related to printing are described. In order to realize the coordination processing, the coordination server 40 retrieves the services related to the print processing, and can generate a print instruction for coordinating these services. More specifically, the coordination server 40 acquires location information representing a position of nodes for executing the services related to the print processing on the network 2 in advance, acquires interface information representing an input/output relationship of the processing devices and application programs from the processing devices for executing the services related to the print processings dispersed on the network 2 on the basis of the location information, and manages the interface information. On the basis of the acquired interface information, the coordination server 40 generates an HTML file serving as a GUI screen for defining a job flow (manner of coordination between the services) and transmits it to the client terminal 10 according to the request from the client terminal 10.

The client terminal 10 transmits the job flow information defined by an operation of a user to the coordination server 40 in CGI form. The coordination server 40 forms a print instruction which defines information of contents of processings requested from the services, the input parameter, the manner of coordination of the services (job flow), information for specifying a document to be processed such as a document name and storage location information, on the basis of job flow information related to instruction of service coordination from the user and interface information of each of the service. The print instruction is constituted by files described in another description format.

The coordination server 40 can interpret and execute the print instruction. The coordination server 40 interprets the print instruction received from the client terminal 10, sequentially calls service processing devices of the processing devices (image forming device 62 and the like in the embodiment) according to an order and a utilization method described in the print instruction, and executes the coordination processings. The coordination server 40 can store information of the status of activated coordination processing or the result of a finished coordination processing and carry out notification of the status and results of the coordination processings in response to an external request.

When the coordination server 40 interprets the print instruction to make requests to the service processing devices, the coordination server 40 generates individual instruction information including the processing request contents, the input parameters, and information for specifying the document to be processed. The coordination server 40 may describe relationships between processings performed before and after the processings performed by the service processing devices in the print instruction or may make a processing request in information exchange formats particular to processing devices or application programs which execute the services instead of the format of the print instruction.

The image forming device 62 which is an example of a device which performs a print service performs a document processing, i.e., printing, on the basis of the information of the service processing request contents, the input parameter, and the information of the document to be processed, included in the processing request from the coordination server 40. The image forming device 62 notifies the coordination server 40 of its own interface information when it is activated. The interface information is used when a print instruction is prepared.

Specific processes are as follows.

A service processing device such as the image forming device 62 notifies the coordination server 40 of interface information including the outlines of services and addresses in an activation processing. The coordination server 40 stores interface information transmitted from each of the service processing devices such as the image forming device 62.

The client terminal 10 accesses a URL of an HTML file generated for a user interface screen arranged in the client terminal 10 or provided by another server through an installed browser according to an operation of a user. In response to a browsing request, the HTML file of a user interface screen is transmitted from the access destination to the client terminal 10, and the screen is displayed on the client terminal 10. At this time, the user can define a flow of desired print processing coordination (to be referred to as a print coordination flow hereinafter) by using the user interface screen displayed on the client terminal 10.

When the print coordination flow is defined through the user interface screen, the client terminal 10 transmits print coordination flow information related to print coordination defined by the user to the coordination server 40.

The coordination server 40 prepares a print instruction which defines information of the contents of processings requested from the services, an input parameter, a manner of coordination of the services, information for specifying a document to be processed such as a document name or storage location information on the basis of print coordination flow information transmitted by the client terminal 10 and interface information obtained from each processing device (step 120). The coordination server 40 obtains a print instruction described in another description format.

The coordination server 40 then starts execution of the coordination processing depending on the print instruction obtained by the instruction of the client terminal 10 (steps 122 to 128).

The coordination server 40 interprets the print instruction and requests the first processing described in the print instruction to execute a corresponding service processing (step 122). In this case, a RIP processing which generates a raster image for printing corresponds to the processing. The coordination server 40 forms individual instruction information for the DFE device 20 and transmits the information to the DFE device 20. In the DFE device 20, the RIP processing which generates a raster image is executed. When the processing is completed, the DFE device 20 transmits processing results such as status information of the processing (completion), an output parameter, storage location information of the document obtained by the processing (location information of the DFE device 20 or another device) and the like to the coordination server 40.

The coordination server 40 then interprets the print instruction and requests the next processing described in the print instruction to execute a corresponding service processing (step 124). In this case, the print processing which forms a print in the image forming device 62 corresponds to the processing. The coordination server 40 forms individual instruction information for the image forming device 62 and transmits the information to the image forming device 62. The image forming device 62 executes a print processing. When the processing is completed, the image forming device 62 transmits processing results such as status information of the processing (completion), an output parameter, storage location information of the document obtained by the processing (location information of the image forming device 62 or another device) and the like to the coordination server 40.

The coordination server 40 then interprets the print instruction to decide whether a next processing is described in the print instruction. When an unprocessed service is described in the print instruction (the determination is negative in step 126), the processings are repeated. On the other hand, when all of the processings are completed (the determination is affirmative in step 126), the completion of the processings described in the print instruction is recognized, and corresponding post-processings are executed (step 128). In this case, the post-processings correspond to those such as delivery of prints formed in the image forming device 62 or classification of prints.

The coordination server 40 can manage the processing results and the processing request results of the image forming device 62 or the like as a log.

Print Instruction in Manual Instruction Format

Processes corresponding to a print instruction in a manual instruction format will be described below. In this case, the print instruction is described in a description format which does not depend on the formats described above, and a user performs print-related processings by an individual notification or a notification made by another communication mode. Namely, the print instruction of the manual instruction format is prepared by the client terminal 10 (step 130).

All information related to control of a coordination processing of services related to printing must be described in the print instruction in the manual instruction format. For this reason, in the client terminal 10, in order to describe all information related to the control of the coordination processing of the services related to printing, a template in which all of the information can be described is prepared, information is entered (input) into this template to prepared the data of the print instruction, and the print instruction is printed. On the basis of the resultant printout, the user performs manual instruction to realize the coordination processing of the services related to printing with a manual operation.

(Merging of Automation Flow of Printing and Job Flow of Electrophotography)

As described above, in the print processing system 1 of the embodiment, a printing process using a conventional printing plate or the like or a printing process by the electrophotographic method can be executed on the basis of a first print instruction by a JDF or a second print instruction by another description format of XML (see FIG. 5). The MIS device 30 controls the print service by the first print instruction by the JDF, and the coordination server 40 controls the print service by the second print instruction of the another description format of XML.

However, regarding the control by MIS device 30 and the control by the coordination server 40, the specification of the description format of the instructions are different, so that it is difficult for one to interpret the other. Therefore, it has been difficult for some processing devices to carry out processing according to a print instruction of a description format different from that of a print instruction that can be interpreted by the processing device. For this reason, in the embodiment, in order to make the printing process executable without being limited by the description format of the print instruction (namely, merging of automation flow of printing and job flow of electrophotography), the processing device is provided with an agent function unit having management functions for managing the specification of the description format.

The managing functions that this agent function unit has include, for example, a function for acquiring an operation state (connection state, operable state, or the like) of the processing device, a function for generating and issuing a print instruction of a description format that can be interpreted by the processing device, a function for changing (setting or selection) the processing device in accordance with the operation state of the processing device, and the like.

In the following description, as one example of achieving a management function, the case of executing one process contained in a printing process that is instructed by the first print instruction (JDF) will be described. Here, the case will be described in which the BEP device 60 is adopted as the processing device, where a processing device capable of interpreting a first print instruction (JDF) (DDCP device 64), and a coordination server capable of interpreting a second print instruction having a different description format (image forming device 68) are provided under control of an agent function unit 60X. As one example, the case will be described in which, when printing for pre-print color proofing is instructed by a first print instruction, the process is allowed to be executed by a device capable of processing on the basis of a second print instruction.

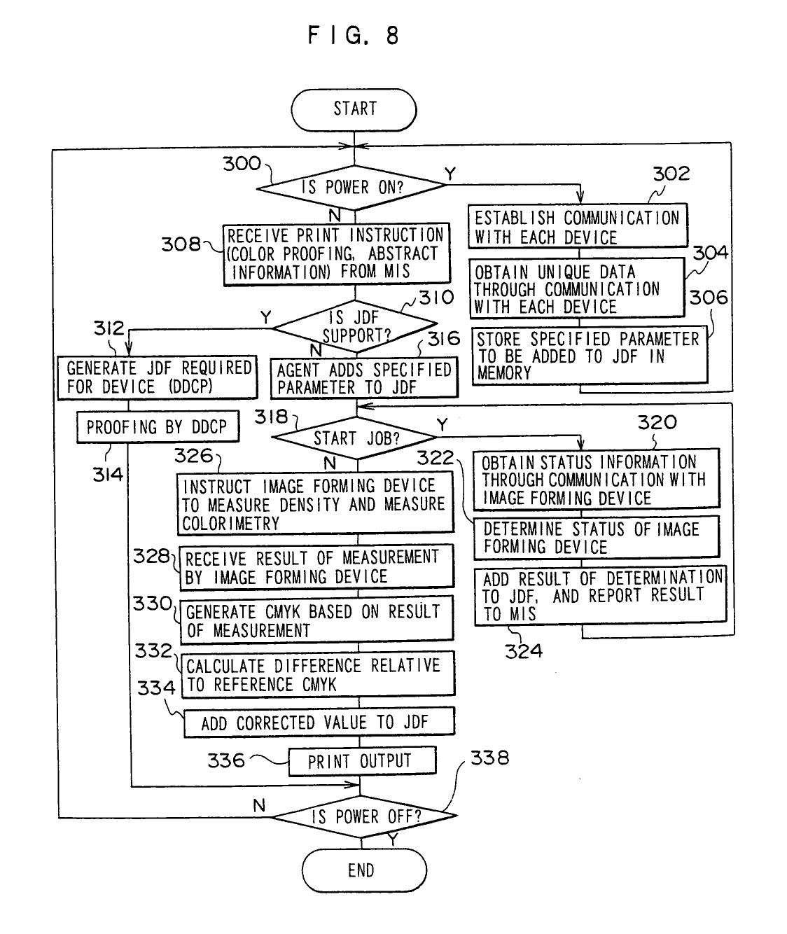

Here, FIG. 8 shows the process of the BEP device 60 (agent function unit 60X) regarding the process executed when an instruction for color proofing is included in the printing-related process defined in the first print instruction, which corresponds to the process on the processing device side of steps 112 and 114 of FIG. 5. Further, in order to make the printing process executable without being limited by the description format of the print instruction, the BEP device 60 has a function of executing generation of a first print instruction and generation of a second print instruction, and also has a function of converting the first print instruction to the second print instruction.

First, the MIS device 30 outputs the first print instruction by JDF to the processing device corresponding to each print process of a DTP device 11, a DDCP device 58, and the BEP device 60. This allows each processing device to process a print service. In other words, in the DTP device 11, an agent function unit 11X receives the first print instruction and performs a process based thereon, and in the DDCP device 58, an agent 58X receives the first print instruction and performs a process based thereon. In the BEP device 60, the agent function unit 60X receives the first print instruction and performs a process based thereon.

The BEP device 60 is constructed with the agent function unit 60X and a job flow engine 60Z, where the job flow engine 60Z executes a process similar to that of the above-described job flow engine 62Z. The agent function unit 60X is for interpreting the inputted print instruction and outputting data or commands to one of the DDCP device 64 and the image forming device 68 which are under control thereof. The agent function unit 60X has functions of grasping the specification of the description format of the print instruction, converting between the first print instruction (JDF) and the second print instruction (another description format), supplying data to an abstract print instruction in which the detailed device specifications are not described, and transmitting and receiving to and from the MIS device 30 (or coordination server 40). Further, the agent function unit 60X has a selection unit 60Y that switches the target of data input and output between the DDCP device 64 which is the processing device that is in charge of the first print instruction (JDF) and the image forming device 68 that is in charge of the second print instruction via the job flow engine 60Z, which are under control of the BEP device 60.

The agent function unit 60X outputs by switching the target to a requested device with selection unit 60Y in correspondence with the specifications of the print instruction. Here, when an instruction by the first print instruction (for example, JDF) is inputted to the image forming device 68, the agent function unit 60X converts the first print instruction to the second print instruction and outputs to the job flow engine 60Z. In this case, the agent function unit 60X includes a process of grasping the unique data of the image forming device 68.

Further, the job flow engine 60Z has functions of ascertaining instructions and commands from the agent function unit 60X, interpretation of a print instruction described in the second description format (for example, another format by XML), acquiring the unique data of the image forming device 68, and data conversion to the unique language (data based on the unique specifications) of the image forming device 68, converts the data according to the print instruction described in the second description format (for example, another description format by XML) that is outputted from agent function unit 60X, to make the data conform to the unique specification of image forming device 68 and outputs the data to the image forming device 68.

The BEP device 60 receives the print instruction and executes the processes based thereon as follows. Here, the case of receiving the first print instruction is presumed.

Referring to FIG. 8, the BEP device 60 determines whether the power has been turned on in step 300, and if the determination is affirmative, the flow proceed to step 302. In step 302, the agent function unit 60X establishes a connection state (so-called on-line state) in which giving and receiving of data to and from each device by communication is possible, and in the next step 304, acquires from each device, i.e., the DDCP device 64 and the image forming device 68 via the job flow engine 60Z, the unique data representing the characteristics of the device, such as the characteristics unique to the device. In particular, regarding the image forming device 68, since it performs an electrophotographic process, the agent function unit 60X acquires detailed unique data. The unique data of the image forming device 68 include data of the image forming device 68 unique to the device type.

The data unique to the device type include parameters representing an instruction of two-sided printing or one-sided printing at the time of forming images, parameters representing an instruction of whether the image surface is the front or back at the time of outputting prints after forming the images, parameters representing specifications of the printing speed and the paper thickness, parameters representing the presence or absence of other connected devices or the connected device name, parameters representing the paper size, parameters representing the kind of screen usable at the time of forming the images, and parameters representing the number of gradations at the time of forming the images. Further, the data can include printing conditions unique to the device such as the order of the pages to be printed and the page sequence specifying the page order at the time of compressing plural pages into one page. These parameters may be stored in an internal memory, for example, as predetermined parameters and used by being read out from the memory, or alternatively those set by operation of the user may be used. If the job flow engine 60Z has already ascertained these unique data, the data may be just read from the job flow engine 60Z.

When the above-described unique data have been acquired, the parameters to be added to the first print instruction (JDF) is stored into a memory (not illustrated) in the next step 306. This process is to store data to be used for supplying data in the first print instruction by the agent function unit 60X when a request for processing by the first print instruction (JDF) is given to the image forming device 68 using the electrophotography method.

When the determination is negative in the above step 300, the flow proceeds to step 308, and waits until a print instruction is received from the MIS device 30. The print instruction to be received in this step 308 may be an abstract instruction for color proofing when the print instruction is a first print instruction. In the next step 310, it is determined whether the device specified by the received print instruction is a device capable of interpreting a print instruction according to the specifications of the first description format. Here, it is assumed that the agent function unit 60X has beforehand ascertained the specifications (format) of the print instruction that can be interpreted by the devices under control of the BEP device 60 (the DDCP device 64 and the image forming device 68 in the embodiment).

When the received print instruction is directed to the DDCP device 64 described by JDF, the determination is affirmative in step 310, and the first print instruction needed for giving an instruction to the DDCP device 64 is generated in step 312 and is outputted in the next step 314. In this step 314, the process of color proofing is executed in the DDCP device 64. Thereafter, when the power is shut down (affirmative determination in step 338), this routine is ended.

When the received print instruction is directed to the image forming device 68 of the first description format (JDF), the determination is negative in step 310, and the flow proceeds to step 316. In step 316, the parameters stored in the above step 306 are added to the received first print instruction. This can generate a first print instruction containing the data for conversion from the abstract information (here, color proofing) of the received first print instruction to the second print instruction which demands a detailed description (another description format by XML).

In the next step 318, whether it is the time for starting the print processing (job) or not is determined. This determination is for acquiring the data that change due to the processing in the image forming device 68. If it is the time for starting the print processing (job) (affirmative determination in step 318), the flow proceeds to step 320, and the status information representing the current state that changes due to the processing in image forming device 68. In this step 320, first, the agent function unit 60X requests the job flow engine 60Z to output the current state of the image forming device 68. In response to this, the job flow engine 60Z gives and receives data to and from the image forming device 68 to obtain the following data. The data of the current state of the image forming device 68 include, for example, the amount of toner consumption, remaining amount of toner, remaining amount of paper (for each size), stopping of the device due to entanglement of paper (a so-called jam), the waiting time (so-called que), and the like. The job flow engine 60Z acquires these data and outputs the data to the agent function unit 60X.

In the next step 322, the device state of the image forming device 68 is determined. This determination is carried out in the agent function unit 60X, and examples of the determination items include management of the due dates and the timing for exchange of the consumable supplies. The management of the due dates can be determined by the stopping of the device or the waiting time, and the timing for exchange of the consumable supplies can be determined by the amount of toner consumption, the remaining amount of toner, and the remaining amount of paper. In the next step 324, the results of the determination in the above step 322 are added to the received first print instruction and reported (transmitted) to the MIS device 30, whereafter the flow returns to step 318. As a result, the MIS device 30 can ascertain the device state under control of the BEP device 60.

When the start of the above print processing (job) is ended (negative determination in step 318), the flow proceeds to step 326, whereby an instruction for densitometric measurement and measurement of colorimetry is given to the image forming device 68. First, the agent function unit 60X requests job flow engine 60Z to output a density reference patch of the image forming device 68. In this case, the agent function unit 60X can output the density reference data to the job flow engine 60Z. In response to this, the job flow engine 60Z gives and receives data to and from the image forming device 68 to obtain density data (colorimetry values). In other words, the job flow engine 60Z gives a request for outputting of colorimetry values to the image forming device 68. In response to this, the image forming device 68 forms predetermined density reference patchs, performs colorimetry with respect to the plural patches with a sensor provided beforehand, and replies to the job flow engine 60Z with the plural colorimetry values for each patch (L*a*b* and the like). The job flow engine 60Z outputs these data to the agent function unit 60X.

In the next step 328, the results of instruction (results of measurement) are received, and CMYK data are generated on the basis of the above received results of measurement in the next step 330. In this step 330, the received plural colorimetry values are averaged to generate the CMYK data. In the next step 332, differences between the CMYK data generated in the above step 330 and the predetermined reference CMYK data are calculated. As a result, the amount of change of the image forming device 68 relative to the reference of each color can be grasped.

In the next step 334, the differences relative to the reference CMYK data determined in the above step 332 are added to the above received first print instruction as correction values. As a result, the agent function unit 60X can generate a print instruction in a state in which detailed correction values for the color are appended in image forming device 68 under control of the BEP device 60. In the next step 336, the agent function unit 60X outputs the print instruction to the job flow engine 60Z. In response to this, job flow engine 60Z outputs data to the image forming device 68, whereby a print output is performed from the image forming device 68. In other words, when the image forming device 68 receives the second print instruction from the job flow engine 60Z, the image forming device 68 executes a print processing for color proofing in accordance with the second print instruction. In this step 336, the agent function unit 60X carries out a process of conversion from the first print instruction (JDF format) to the second print instruction (another description format). Since the agent function unit 60X has already acquired detailed data for generating the second print instruction as described above, the conversion can be carried out easily.

In this manner, in the embodiment, when an instruction for printing for color proofing has been given when executing a print processing in accordance with the first print instruction by JDF, if the object processing device can interpret only the second print instructions (another description format by XML or the like), a second print instruction by another description format by XML or the like corresponding to the first print instruction is generated (converted) and outputted. In this case, the agent function unit 60X acquires beforehand various data needed for operating the image forming device 68, and even if an abstract and ambiguous instruction is given in the first print instruction, these data are automatically added. Therefore, a detailed instruction can be output to the image forming device 68 capable of processing on the basis of the second print instruction, and makes image forming device 68 execute a print processing for color proofing.

This facilitates merging of an automation flow of printing by the first print instruction and a job flow of electrophotography by the second print instruction. Further, image outputs and character outputs conventionally processed by the automation flow of printing by the first print instruction can be output easily and speedily from a processing device compatible with the job flow of electrophotography by the second print instruction. Further, the printed matter output from a processing device compatible with the job flow of electrophotography by the second print instruction can be processed in a processing device conforming to the automation flow of printing by the first print instruction.

Here, the process of receiving the above described print instruction (step 308) corresponds to the operation of the input unit of the invention. Further, the processing of acquiring the unique data of the device (step 304) and the process of acquiring the status information (step 320) corresponds to the operation of the acquiring unit of the invention. Further, the process of generating the first print instruction (step 312), the process of appending the parameters (step 316) and the process of appending the correction values (step 334) corresponds to the operation of the generating unit of the invention. Further, the process of outputting the generated print instruction (step 336) corresponds to the operation of the output unit of the invention. Further, the selection unit 60Y that the agent function unit 60X is equipped with corresponds to the switching unit of the invention. Further, one example of the first processing unit of the invention corresponds to the DDCP device 64, and one example of the second processing unit corresponds to the image forming device 68. The print management device corresponds to the BEP device 60 including the agent function unit 60X and the job flow engine 60Z.

Here, in the embodiment, description has been given for the case of adopting color proofing as one example of the print processing. However, the print processing is not limited to only color proofing. In other words, the invention can be applied to any processing device that is in charge of a print processing contained in the print instruction.

Further, in the embodiment, processing has been described with respect to a processing device capable of interpreting the second print instruction but not capable of performing a process based on the first print instruction. However, it goes without saying that the invention can be applied to a process according to the second print instruction by a processing device capable of interpreting the first print instruction but not capable of performing a process based on the second print instruction which is different from the first print instruction.

Furthermore, in the embodiment, description has been given for the case of in which the color proofing process is executed by the DDCP device 64 or the image forming device 68 connected under control of the BEP device 60. However, the invention is not limited to controlling a processing device that is independently connected. For example, the invention can be applied to the case of executing a print processing for color proofing by the DDCP device 58 or the image forming device 62 directly connected to the network 2. This case can be easily realized by equipping the selection unit 60Y of the agent function unit 60X with an interface that can be connected to another device via the network 2. Here, it is preferable to adopt a configuration in which the process in the above BEP device 60, particularly the process of agent function unit 60X, is performed independently under connection to the network 2.

As described above, the invention can be realized in a print system containing a processing unit for processing a printing-related service in accordance with a print instruction in which the request items representing the request for producing printed matters are described, as a print management device for managing the printing-related service that is processed in the processing unit.

In the print management device, the unique data can contain at least one of the structural data representing the structural elements of the relevant processing unit when a printing-related service is processed in the processing unit and the variable data that vary due to execution of the process in the processing unit.

In the case where the processing unit is constructed with a device, when executing a process related to the printing-related service being processed, some processes are depend on the construction of the device and the consumable supplies. For example, when prints or printed matter are outputted, there are setting processes dependent on the structural elements of the device such as selection of the paper size, direction of image forming, and whether the images are on the front or back when the formed images are outputted. Therefore, by including the structural data representing the structural elements of the processing unit in the unique data, the setting or processing by the structural elements of the processing unit is facilitated. Further, if the processing unit forms images by the electrophotographic method, a medium related to forming printed matter such as toner or paper is necessary. This medium related to forming printed matter is consumed by use, so that the remaining amount thereof must be managed. For this reason, by including in the unique data, the variable data that vary due to execution the process in the processing unit such as the toner amount and the remaining amount of paper, the setting or processing depending on the consumable supplies (medium related to forming printed matter) of the processing unit is facilitated.

The acquiring unit can be constructed to include a connection unit that is connected to the processing unit, and the unique data and the description format can be acquired by the connection unit.

The print management device may be independently constructed, or may be incorporated into the processing unit. In either case, the processing unit and the print management device must be connected with each other. For this reason, if the acquiring unit to include a connection unit that is connected to the processing unit and the unique data and the description format are acquired by the connection unit, the status of the processing unit can be easily ascertained.

The acquiring unit provided in the print management device can be constructed to include a reading unit that reads a storage medium which stores the unique data and the description format, and the unique data and the description format can be acquired by the reading unit.

In the case of such a construction, acquiring the unique data and the description format is carried out by reading the data. In other words, the acquiring unit includes a reading unit that reads a storage medium which stores the unique data and the description format, and the unique data and the description format are acquired by the reading unit. As a result, the unique data and the description format that are stored in a storage medium or the like by being made into data can be easily acquired.

The acquiring unit can be constructed to obtain the unique data and the description format when the power of the processing unit is turned on or when the processing of the processing unit is started.

The unique data of the processing unit include data that are dependent on the device construction and invariable, or data that change in accordance with the processing. The description format corresponding to one device is determined in advance. Therefore, by the acquiring unit acquiring the unique data and the description format when the power of the processing unit is turned on, the status of the processing unit can be easily ascertained at the time when the processes of the processing unit are initially started. Further, considering those that change due to use, by carrying out the acquiring when the processes are started, the status of the processing unit can be easily ascertained at the time when the processes of the processing unit are started.

The generating unit provided in the print management device can be constructed to generate the inputted print instruction, as it is, as the operation instruction when the inputted print instruction is described in a description format that can be interpreted by the processing unit (i.e., if the processing unit can interpret the print instruction and execute it as it is, the generating unit allows the print instruction to pass as it is).

As a result, the process of generating the operation instruction manual can be omitted, thereby lightening the processing load and reducing the processing time.

The processing unit can be constructed to include a first processing unit that processes in accordance with a print instruction in which the request items representing the request for producing printed matter are described in a first description format, and a second processing unit that processes in accordance with a print instruction in which the request items are described in a second description format that is different from the first description format, and the print management device can be provided with a switching unit for switching so as to select the processing unit that processes the printing-related service to the first processing unit or the second processing unit on the basis of the description format of the inputted print instruction.

This construction can be applied to the case in which the print management device manages plural processing units. In other words, the processing units include a first processing unit that processes in accordance with a print instruction in which the request items representing the request for producing printed matter are described in a first description format and a second processing unit that processes in accordance with a print instruction in which the request items are described in a second description format that is different from the first description format. In this case, the switching unit switches the processing unit that processes the printing-related service to the first processing unit or the second processing unit on the basis of the description format of the inputted print instruction. By this switching unit, the processing unit can be smoothly switched to the processing unit corresponding to the description format of the print instruction.

Further, the invention can be provided as a method of operating a print management device constructed as described above, or as a storage medium that stores a program for operating a print management device constructed as described above.

1. A print management device for managing a print-related service to be performed by a processing unit which performs the print-related service according to a print instruction containing a request item indicating a request to produce printed matter comprising:
an input unit that inputs the print instruction;
an acquiring unit that acquires unique data indicative of characteristics of the processing unit and a description format which can be interpreted by the processing unit;
a generating unit that generates an operation instruction as to the request item contained in the inputted print instruction, the operation instruction being described in the description format which can be interpreted by the processing unit and being based on the unique data; and
an output unit that outputs the generated operation instruction as the print instruction to the processing unit.

2. The print management device according to claim 1, wherein the unique data comprises at least one of structural data indicating a structural element of the processing unit, which is involved when the processing unit performs the print-related service, and variable data varying when the processing unit executes a process.

3. The print management device according to claim 1, wherein the acquiring unit comprises a connection unit that connects to the processing unit, and the acquiring unit acquires the unique data and the description format through the connection unit.

4. The print management device according to claim 1, wherein the acquiring unit includes a reading unit that reads data from a storage medium which stores the unique data and the description format, and the acquiring unit acquires the unique data and the description format through the reading unit.

5. The print management device according to claim 1, wherein the acquiring unit acquires the unique data and the description format at the time when a power source of the processing unit is turned on or when the processing unit starts a process.

6. The print management device according to claim 1, wherein the generating unit generates the operation instruction using the inputted print instruction as it is, when the inputted print instruction is described in a description format which can be interpreted by the processing unit.

7. The print management device according to claim 1 further comprising a switching unit,
wherein the processing unit comprises a first processing unit that executes a process according to a print instruction containing the request item indicating the request to produce printed matter, the request item being described in a first description format; and a second processing unit that executes a process according to a print instruction containing the request item described in a second description format which is different from the first description format, and the switching unit switches so as to select the first processing unit or the second processing unit as the processing unit which performs the print-related service in accordance with the description format of the inputted print instruction.

8. A print management method for managing a print-related service to be performed by a processing unit which performs the print-related service according to a print instruction containing a request item indicating a request to produce printed matter comprising:
inputting the print instruction;
acquiring unique data indicative of characteristics of the processing unit and a description format which can be interpreted by the processing unit;
generating an operation instruction as to the request item contained in the inputted print instruction, the operation instruction being described in the description format which can be interpreted by the processing unit and being based on the unique data; and
outputting the generated operation instruction as the print instruction to the processing unit.

9. The print management method according to claim 8, wherein the unique data comprises at least one of structural data indicating a structural element of the processing unit, which is involved when the processing unit performs the print-related service, and variable data varying when the processing unit executes a process.

10. The print management method according to claim 8, wherein the acquiring comprises acquiring the unique data and the description format by connecting to the processing unit.

11. The print management method according to claim 8, wherein the acquiring comprises acquiring the unique data and the description format by reading data from a storage medium which stores the unique data and the description format.

12. The print management method according to claim 8, wherein the acquiring comprises acquiring the unique data and the description format at the time when a power source of the processing unit is turned on or when the processing unit starts a process.

13. The print management method according to claim 8, wherein the generating comprises generating the operation instruction using the inputted print instruction as it is, when the inputted print instruction is described in a description format which can be interpreted by the processing unit.

14. The print management method according to claim 8, further comprising switching the processing unit, wherein the processing unit comprises a first processing unit that executes a process according to a print instruction containing the request item indicating the request to produce printed matter, the request item being described in a first description format; and a second processing unit that executes a process according to a print instruction containing the request item described in a second description format which is different from the first description format, and the switching comprises selecting the first processing unit or the second processing unit as the processing unit which performs the print-related service in accordance with the description format of the inputted print instruction.

15. A computer-readable storage medium which stores a program to perform a processing of managing print processing for printed matter executable by a print management device, the print management device managing the print-related service to be performed by a processing unit which performs a print-related service according to a print instruction containing a request item indicating a request to produce printed matter, comprising:
inputting the print instruction;
acquiring unique data indicative of characteristics of the processing unit when it performs the print-related service and a description format which can be interpreted by the processing unit;
generating an operation instruction as to the request item contained in the inputted print instruction, the operation instruction being described in the description format which can be interpreted by the processing unit and being based on the unique data; and
outputting the generated operation instruction as the print instruction to the processing unit.

16. The storage medium according to claim 15, wherein the unique data comprises at least one of structural data indicating a structural element of the processing unit, which is involved when the processing unit performs the print-related service, and variable data varying when the processing unit executes a process.

17. The storage medium according to claim 15, wherein the acquiring comprises acquiring the unique data and the description format by connecting to the processing unit.

18. The storage medium according to claim 15, wherein the acquiring comprises acquiring the unique data and the description format by reading data from a storage medium which stores the unique data and the description format.

19. The storage medium according to claim 15, wherein the acquiring comprises acquiring the unique data and the description format at the time when a power source of the processing unit is turned on or when the processing unit starts a process.

20. The storage medium according to claim 15, wherein the generating comprises generating the operation instruction using the inputted print instruction as it is, when the inputted print instruction is described in the description format which can be interpreted by the processing unit.

21. The storage medium according to claim 15, wherein:
the processing further comprises switching the processing unit,
the processing unit includes a first processing unit that executes a process according to a print instruction containing the request item indicating the request to produce printed matter, the request item being described in a first description format; and a second processing unit that executes a process according to a print instruction containing the request item described in a second description format which is different from the first description format, and the switching comprises selecting so as to select the first processing unit or the second processing unit as the processing unit which performs the print-related service in accordance with the description format of the inputted print instruction.

22. A print system which performs a print-related service according to a print instruction containing a request item indicating a request to produce printed matter, the system comprising:
at least one processing unit corresponding to at least one printing process, the processing unit being classified in advance according to printing processes which provide print-related services classified in advance between the request and the delivery of printed matter; and
a print management device that manages a print processing for printed matter to be performed by the processing unit,
wherein the print management device includes:
an input unit that inputs the print instruction;
an acquiring unit that acquires unique data indicative of characteristics of the processing unit and a description format which can be interpreted by the processing unit;
a generating unit that generates an operation instruction as to the request item contained in the inputted print instruction, the operation instruction being described in the description format which can be interpreted by the processing unit and being based on the unique data; and
an output unit that outputs the generated operation instruction as the print instruction to the processing unit.
